(19) United States
(12) Patent Application Publication
(10) Pub. No.: US 2018/0165777 A1
(43) Pub. Date: Jun. 14, 2018

(54) METHOD OF, AND SYSTEM FOR, OBTAINING OR PROVIDING LEGAL SERVICES OR ADVICE

(71) Applicant: BELLATOR PTY LTD, Queensland (AU)

(72) Inventors: Stephen Con Kriticos, Sydney (AU); Dale Cameron Watson, Sydney (AU)

(21) Appl. No.: 15/580,884

(22) PCT Filed: Jun. 9, 2016
(86) PCT No.: PCT/AU2016/050466

§ 371 Date: Dec. 8, 2017

(30) Foreign Application Priority Data
Jun. 10, 2015 (AU) 2015902195
Feb. 26, 2016 (AU) 2016900689
Feb. 27, 2016 (AU) 2016900717
May 24, 2016 (AU) 2016901966

(51) Int. Cl. G06Q 50/18; G06Q 10/10

(52) U.S. Cl. CPC G06Q 50/184; G06Q 10/101

(57) ABSTRACT

A programmable network arranged for obtaining or providing legal services or advice includes brief storage for storing a brief of one or more legal service or advice seekers seeking a corresponding service or corresponding advice and legal service provider or advisor brief storage access arranged for enabling access by one or more legal service providers or advisors to the brief storage. The brief storage access is further arranged for selective access by each of the one or more legal service providers or advisors to each brief of the one or more legal service or advice seekers. A method of obtaining or providing legal services or advice includes storing a brief of one or more legal service or advice seekers seeking a corresponding service or corresponding advice and one or more legal service providers or advisors selectively accessing each brief.

### FIELD OF THE INVENTION

The present invention broadly relates to the fields of legal services and advice. More specifically it relates to obtaining or providing legal services or advice. More specifically still it relates to, but is not limited to, obtaining or providing Intellectual Property (‘IP’) services or advice. More specifically again it relates to, but is not limited to, obtaining registered IP rights, for example, those relating to patents, trademarks and designs.

### BACKGROUND OF THE INVENTION

Legal services or advice can be, and typically is, expensive. With respect to one particular field of legal services or advice, specifically that relating to IP, in some cases IP owners or originators apply for corresponding registered IP rights themselves. This has cost benefits but can, for example, at least contribute to problems or difficulties in the applications, or deficiencies in any registered IP rights that may be obtained.

Typically, advisors, for example, patent attorneys and lawyers, are engaged to provide advice in relation to the IP. Patent attorneys and lawyers are, for example, typically also engaged to prepare and file patent applications applying for corresponding registered IP rights. Advisors are typically similarly used in relation to other IP, for example, IP comprising trademarks and designs.

Registered IP rights can be sought with the intention of, and prior to, commercialising the corresponding IP. In some cases, for example patentable IP, it is also typically necessary or at least beneficial to apply for corresponding registered IP rights prior to commercialisation.

Applying for or obtaining registered IP rights, and the corresponding commercialisation, is typically complex, expensive and uncertain. It is also typically difficult to compare services or advice provided by IP advisors and their fees. These difficulties with obtaining legal services or advice typically apply to other legal service providers or advisors. It is therefore desirable to provide alternative means of applying for, obtaining or providing legal services or advice which in at least one aspect at least partly addresses one or more of these possible shortcomings.

### SUMMARY OF THE INVENTION

In one aspect of the present invention there is provided a method of applying for or obtaining registered IP rights comprising an agreement between an owner or originator of said IP or a prospective applicant of an application for registration of said registered IP rights, and a registering party, said registering party being authorised, by one or more corresponding registering organisations which grant or issue said registered IP rights, to act on behalf of said owner or originator or prospective applicant in relation to said registered IP rights, said method comprising the steps of:
a. payment by said owner or originator or prospective applicant to said registering party of an assessment fee for assessment of registrability of said IP; and
b. if said assessment is that the IP is at least likely to be registerable, agreement that said registering party will apply for said registered IP rights and said owner or originator or prospective applicant will pay to said registering party a percentage of revenue derived from exploitation of said IP.

Preferably said method of said one aspect further comprises the step of pursuing, at least to a substantially reasonable extent, registration of said registered IP rights. However, said revenue derived from said exploitation is preferably payable to said registering party irrespective of whether said registered IP rights are obtained.

In a preferred form of said one aspect of the present invention said percentage is a percentage of at least substantially all said revenue.

Preferably said registrability assessment is performed by said registering party. However, in an alternative preferred embodiment it is performed by a third party.

In a preferred form of said one aspect of the present invention said method further comprises the step of assessment of commercial merits or viability of said IP. In this further preferred form, the assessment fee also comprises assessment of said commercial merits or viability. Assessment of said commercial merits or viability is preferably performed by a commercialising party. In a more preferred embodiment said commercialising party is at least associated with said registering party, and more preferably said registering party comprises said commercialising party. However, alternatively said assessment of said commercial merits or viability is performed by a third party.

Preferably said assessment comprises a rating. In a more preferred form of said one aspect of the present invention, if said rating is greater than or equal to a predetermined value, said registering party agrees to one or more of: endeavouring, with at least reasonable diligence, to obtaining said registered IP rights; commercialisation advice; or commercialisation assistance. In a more preferred embodiment of said one aspect of the present invention said commercialisation advice or assistance comprises, for example, one or more of: prototyping; and market considerations and recommendations. In a still more preferred form of said one aspect of the present invention if said rating is greater than or equal to a predetermined value said method further comprises the step of registering party agreeing to do all things reasonably necessary for one or more of: lodgement with corresponding registry bodies, for example patent, trademark or design offices or their equivalents, of applications for said registered IP rights and obtaining said registered IP rights; protection or defence of any registered IP rights that have been obtained in relation to deregistration; and enforcement of any registered IP rights that have been obtained in relation to infringement or threatened infringement.

In a more preferred form of said one aspect of the present invention if said rating is greater than or equal to a predetermined value said registering party agrees to pay prescribed fees of said agreement. Said prescribed fees preferably comprise official fees, said official fees being those payable to said registering organisations. Preferably, said prescribed fees further comprise substantially all official fees. In a more preferred embodiment said prescribed fees further comprise substantially all other fees, for example, those of any other registering parties engaged by said registering party to apply for and obtain registered IP rights in relation to other jurisdictions.

In a still more preferred form of said one aspect of the present invention said assessment fee is at least substantial. For example, in one preferred embodiment said assessment fee is in the order of about $1,000-$20,000. More preferably said assessment fee is multi-tiered, different tiers corresponding to predetermined ranges of values of said rating. In a yet more preferred form of the present invention said assessment fee is payable at predetermined stages of a corresponding process of applying for or obtaining registered IP rights. For example, an initial assessment fee for assessment of the registrability of the IP and a subsequent fee relating to application(s) for registration and commercialisation of said IP.

Preferably said assessment fee is inversely proportional to said percentage of revenue derived from exploitation of said IP. For example, said assessment fee may be in the order of approximately $5,000 for a value of said percentage of revenue in the order of approximately 30%. However, if said percentage of said revenue is instead approximately 15% then said assessment fee may, for example, be in the order of approximately $15,000.

In another preferred form of said one aspect of the present invention the value of said assessment fee may additionally, or alternatively, be inversely proportional to the value of said rating. For example, for a rating of 4.5/5 said assessment fee may be in the order of $3,000 for a value of said percentage of said revenue of approximately 20%. However, for the same revenue percentage, if the value of the rating was instead 2 then the assessment fee may, for example, increase to $10,000.

In one preferred form of said one aspect of the present invention said method further comprises the step of utilising one or more capital raising platforms or applications, for example, ‘Crowd Funding’ by Google Inc. More preferably however said capital raising is only undertaken after applications relating to said step of said registering party applying for said registered IP rights have been filed with corresponding said registering organisations, or a decision has been made not to pursue such applications.

Another preferred embodiment of said one aspect of the present invention further comprises the step of assigning said IP from said owner or originator or prospective applicant to said registering party. Said method preferably further comprises the step of licencing back to said owner or originator or prospective applicant. Said licence is preferable exclusive and irrevocable. However, said licence may allow sub-licencing. More preferably said licence is of unlimited term. Still more preferably, said irrevocability is voided if revenue payable to said registering party is not paid to that party. Preferably said irrevocability is only voidable if said revenue is not paid without good reason.

In a still other preferred embodiment of said one aspect of the present invention said method further comprises the step of considering whether there may be a conflict of interest in carrying out steps of said method, and before disclosure of any information relating to said IP other than publically available information. This consideration step is also preferably carried out prior to payment of said assessment fee.

In a yet another preferred embodiment of said one aspect of the present invention any said steps agreed to by said registering party, or otherwise any agreement by said registering party in accordance with said method of applying for said registered IP rights, may be voided if one or more of the following apply and are relevant to said agreement: information known to but not disclosed by said owner or originator or prospective applicant to said registering party; information not revealed by searches of an appropriate standard; infringement of third party IP rights; it becomes apparent that the IP is not commercially viable or has limited commercial merit; said owner or originator or prospective applicant do not use their best endeavours to commercialise the IP; or advice or recommendations of the registering party is not implemented.

More preferably, said method of applying for registered IP rights of said one aspect of the present invention excludes litigation relating to said registered IP rights or third party IP rights whether or not registered.

In another aspect of the present invention there is provided a programmable network arranged for obtaining or providing legal services or advice, said programmable network comprising brief storage means for storing a brief of one or more legal service or advice seekers seeking a corresponding service or corresponding advice, and legal service provider or advisor brief storage access means arranged for enabling access by one or more legal service providers or advisors to said brief storage means, wherein said brief storage access means is further arranged for selective access by each of said one or more legal service providers or advisors to each said brief of said one or more legal service or advice seekers.

In a preferred from of said other aspect of the present invention said brief storage access means further comprises time recording means arranged to record time spent by said one or more legal service providers or advisors viewing said brief. Preferably, said brief storage access means is further arranged to convert said viewing time to a corresponding charge. More preferably, said charge is capped. More preferably still a predetermined amount of viewing time is stipulated to be free of charge. In a yet more preferred embodiment chargeable viewing time is required to be preapproved in relation to each said one or more legal service providers or advisors.

Preferably, said brief storage means is further arranged for identifying said one or more legal service or advice seekers. In a more preferred form of said programmable network, said brief storage access means is further arranged to selectively identify said one or more legal service or advice seekers with respect to any one or more of said one or more legal service providers or advisors, any one or more other of said one or more legal service or advice seekers, or both.

In a more preferred form of the system of the present invention said programmable network further comprises legal service provider or advisor storage means arranged for storing information relating to one or more of said one or more legal service providers or advisors. Said legal service provider or advisor storage means is preferably further arranged to selectively identify said one or more legal service providers or advisors with respect to any one or more other of said one or more legal service providers or advisors, any one or more of said one or more legal service or advice seekers, or both.

More preferably, said programmable network further comprises communication facilitation means arranged for at least partially facilitating selective communication between one or more of said one or more legal service or advice seekers and one or more of said one or more legal service or advice providers. Preferably, said communication facilitation means comprises one or more of: said time recording means; and one or more features of said brief storage access means relating to conversion of said viewing time to a corresponding charge. More preferably still, said communication facilitation means is further arranged for at least partially facilitating selective communication at least between one or more of said one or more legal service providers or advisors and one or more other of said one or more legal service providers or advisors. In a yet more preferred embodiment said communication facilitation means is further arranged for at least partially facilitating selective communication between one or more of said one or more legal service or advice seekers and one or more other of said one or more legal service or advice seekers.

In one preferred form of said programmable network of the present invention said brief comprises IP of an owner or originator of said IP or a prospective applicant of an application for registration of corresponding registered IP rights, and said brief storage means correspondingly comprises IP storage means. However, said brief is not limited to IP. It could, for example, comprise a description of a legal matter not related to IP that said legal service or advice seeker is seeking corresponding services or advice in relation to.

Preferably, said programmable network comprises a programmable network arranged for applying for or obtaining registered IP rights. In relation to this preferred form of said programmable network said legal service provider or advisor storage means comprises registering parties storage means, said registering parties being authorised, by one or more registering organisations which grant or issue said registered IP rights, to act on behalf of said owner or originator or prospective applicant in relation to said IP with respect to said registered IP rights being applied for. In this more preferred form of the programmable network of the present invention said brief storage access means comprises IP storage access means arranged for enabling access by one or more of said one or more said registering parties to said IP storage means, wherein said IP storage access means is further arranged for selective access by each of said one or more registering parties in relation to said IP of each said owner or originator or prospective applicant.

Preferably, said IP storage access means comprises authorisation means arranged for authorising said access. In one preferred form of said other aspect of the present invention said authorisation means is arranged for any one or more of said owner or originator or prospective applicant to authorise one or more of said one or more registering parties to access their corresponding IP. In a yet more preferred form, said authorization means is arranged to authorize said access via an invitation of one or more of said owner or originator or prospective applicant to one or more of said one or more registering parties to access their corresponding IP. In a further preferred form of said programmable network said invitation comprises said registering parties of said registering parties storage means. However, alternatively said authorization means may be arranged to invite other registering parties.

More preferably said authorisation means is, additionally or alternatively, arranged for any one or more of said registering parties to authorize their access to IP of any one or more of said one or more owner or originator or prospective applicant. This preferred feature is preferably arranged to at least reduce any likelihood of said access by one or more of said one or more registering parties resulting in a conflict of interest.

More preferably said IP storage access means further comprises IP summary means for providing a summary of said IP relating to one or more of said one or more owner or originator or prospective applicant. With respect to this more preferred feature said authorization means is preferably further arranged to only authorize access in relation to each said summary by one or more of said one or more registering parties upon confirmation by a corresponding registering party that they have reviewed said summary and do not have a conflict of interest in acting in relation to the corresponding IP. More preferably, said IP summary only comprises publically available information relating to said IP. The publically available information is more preferably publically available anywhere throughout the world but at least with respect to the country in which said registering party resides. At least for this purpose said registering party storage means comprises information that identifies said registering party's jurisdiction or jurisdiction of practice, at least in relation to each said IP.

Preferably, the IP summary means is arranged to prompt said legal service or advice seeker for said summary. However, in a more preferred form of said other aspect of the present invention said summary is IP summary means is arranged to automatically prepare said summary. This more preferred form of said IP summary means preferably comprises one or more processors arranged to compare said brief with corresponding publically available information and prepare a summary relating to said brief that only comprises publically available information.

In an alternative form of said other aspect of the present invention said brief storage access means further comprises brief summary means corresponding to said IP summary means. Similarly, in another alternative form of said other aspect of the present invention said brief storage access means further comprises features corresponding to features of said IP storage access means.

Still more preferably said IP summary means does not identify any one or more of said one or more owners or originators or prospective applicants at least to any of said one or more registering parties. By virtue of this still more preferred feature a registering party can confirm whether or not they have a conflict of interest acting in relation to said IP relating to any one or more of said one or more owners or originators or said prospective applicants without the identity of the corresponding persons whom own or are developing said IP being revealed. This ensures a registering party of said one or more registering parties is not, without authorisation, notified that persons have or are developing IP in a particular field. It also enables said one or more owners or originators or said prospective applicants to consider alternative registering parties, or other said service providers or advisors, without revealing this to their current service provider or advisor.

In yet another more preferred embodiment of said other aspect of the present invention said IP storage access means comprises identity authorisation means arranged for identifying one or more of: one or more of said registering parties authorised by one or more of said one or more owners or originators or prospective applicants to act on their behalf; or one or more of said owner or originator or said prospective applicant which one or more of said registering parties authorises that they can act on behalf of.

In another preferred embodiment of said programmable network of said other aspect of the present invention said IP storage access means further comprises authorisation exclusion means arranged for identifying prospective clients or registering parties, including categories of prospective clients or registering parties, for whom said authorisation is not provided. For example, preferably said authorisation exclusion means is arranged to identify one or more of the following: specific organisations, companies or businesses; specific technologies or industries; individuals; small businesses, companies, organisations or institutions; or large businesses, companies, organisations or institutions. Preferably, said authorisation exclusion means is arranged for identifying excluded persons, organisations, technologies or industries by either or both said IP owner or originator or prospective applicant, or said registering parties.

In a preferred embodiment of said other aspect of the present invention said IP storage means is at least substantially secure to at least substantially ensure that access to it can only occur via said IP storage access means.

In a preferred form of said other aspect of the present invention said registering parties storage means is updated or modified by, for example, a said registering party or a third party. Said third party may, for example, comprise an administrator of said system.

More preferably said programmable network of said other aspect of the present invention comprises assessment means arranged for assessment by one or more of said one or more said registering parties of the registrability of said IP. Preferably, said assessment means is arranged to fulfill one or more steps of said assessment of said method of said one aspect of the present invention. More preferably, said assessment means is further arranged to assess said one or more registering parties, or correspondingly said one or more legal providers or advisors. Preferably, said assessment means is arranged to enhance or optimize interaction of said one or more legal service providers or advisors with said brief. Preferably said assessment means is arranged to enhance or optimize access of one or more of said one or more legal service provider or advisor seekers to one or more of said one or more legal service providers or advisors, or one or more of said one or more legal service providers or advisors to one or more other of said one or more legal service providers or advisors.

In a preferred embodiment of said programmable network of the present invention said assessment means comprises assessment selection means for selecting an assessment from a limited number of options, for example, from ratings of 1 to 5, where 5 indicates that the IP is registerable.

In a more preferred form of said other aspect of the present invention said programmable network further comprises proposal communication means for communicating a proposal by either one or more of said one or more legal service provider or advice seekers or one or more of said one or more registering parties, or both of these, of, for example, a service arrangement for provision of a corresponding legal service or advice to either one or more of one or more of said IP owner or originator or prospective applicant or one or more of said one or more registering parties, or both of these. Preferably, said proposal communication means comprises proposal selection means for selecting a proposal from a limited number of options comprising, for example, one or more of: an hourly charge basis; a fixed fee basis; and all-inclusive basis; or any one or more features of said agreement of said method of said one aspect of the present invention. In a still more preferred form of the other aspect of the present invention said programmable network further comprises agreement communication means arranged for confirming agreement between any one or more of said one or more IP owner or originator or prospective applicant and said one or more registering parties, or said one or more registering parties and any one or more other said one or more registering parties. This agreement may, for example, comprise a service or advice agreement. More preferably, said agreement communication means comprises agreement selection means for selecting an agreement derived from, for example, one or more said proposals of said proposal selection means.

In another preferred embodiment of the other aspect of the present invention said programmable network is arranged to communicate with capital raising platforms or applications, for example, ‘Crowd Funding’ by Google Inc. More preferably however, said programmable network is arranged to communicate with said capital raising platforms or applications only after said registered IP rights have been obtained, or a decision has been made to no longer pursue said registered rights.

Preferably, said programmable network of said other aspect of the present invention comprises the internet. More preferably, one or more programmable network features of said programmable network comprising, for example, one or more of said IP storage means, registering parties storage means, IP storage access means, authorization means, IP summary means, identity authorization means, authorization exclusion means, assessment means, assessment selection means, proposal communication means, agreement communication means, agreement selection means, and said arrangement for communication with said capital raising platforms or applications, are connected to the internet for operation at least partially via the internet or optional operation via the internet. More preferably still, said programmable network of the present invention comprises one or more websites.

In a more preferred form of the programmable network of the other aspect of the present invention said programmable network features comprise, as appropriate and as would be understood from skilled persons in the relevant field, corresponding data storage and processing means which more preferably comprise corresponding electronic data storage and processing, and still more preferably, for example, one or more corresponding electronic hard drives and processors. More preferably, said programmable network comprises one or more computers or computer networks comprising said data storage and processing means.

In a yet another aspect of the present invention there is provided a method of operating a programmable network to obtain or provide legal services or advice, said method comprising the steps of storing a brief of one or more legal service or advice seekers seeking a corresponding service or corresponding advice, and one or more legal service providers or advisors selectively accessing each said brief of said one or more legal service or advice seekers. Preferably, said step of storing said brief comprises any suitable storage means, but more preferably comprises computing means, an IT system or any suitable means that would be readily understood by persons skilled in the relevant field.

In a still yet other aspect of the present invention there is provided a method of obtaining or providing legal services or advice, said method comprising the steps of storing a brief of one or more legal service or advice seekers seeking a corresponding service or corresponding advice, and one or more legal service providers or advisors selectively accessing each said brief of said one or more legal service or advice seekers.

In a preferred from of said yet other and still yet other aspects of the present invention said method further comprises the step of recording time spent by said one or more legal service providers or advisors viewing said brief. Preferably, said method further comprises the step of converting said viewing time to a corresponding charge. More preferably, said charge is capped. More preferably still the method further comprises the step of not converting a predetermined amount of viewing time to a corresponding charge so that the predetermined time is provided free of charge by the said one or more legal service providers or advisors. A yet more preferred embodiment further comprises the step of preapproving chargeable viewing time in relation to each said one or more legal service providers or advisors.

Preferably, said step of storing said brief further comprises the step of identifying said one or more legal service or advice seekers. In a more preferred form said method of said yet other and still yet other aspects of the present invention further comprises the step of selectively identifying said one or more legal service or advice seekers with respect to any one or more of said one or more legal service providers or advisors, any one or more other of said one or more legal service or advice seekers, or both.

More preferably, said method of said yet other and still yet other aspects of the present invention further comprises the step of storing information relating to one or more of said one or more legal service providers or advisors. More preferably still, this step further comprises the step of selectively identifying said one or more legal service providers or advisors with respect to any one or more other of said one or more legal service providers or advisors, any one or more of said one or more legal service or advice seekers, or both.

In a more preferred embodiment said method of said yet other and still yet other aspects of the present invention further comprises the step of selective communication between one or more of said one or more legal service or advice seekers and one or more of said one or more legal service or advice providers. Preferably, this step further comprises one or more steps of: recording a period of time of said selective communication; and converting said period of time of said selective communication to a corresponding charge. More preferably still, said method of said yet other and still yet other aspects of the present invention further comprises the step of selective communication at least between one or more of said one or more legal service providers or advisors and one or more other of said one or more legal service providers or advisors. A yet more preferred embodiment further comprises the step of selective communication between one or more of said one or more legal service or advice seekers and one or more other of said one or more legal service or advice seekers.

In one preferred form of said method of said yet other and still yet other aspects of the present invention said brief comprises IP of an owner or originator of said IP or a prospective applicant of an application for registration of corresponding registered IP rights. However, said brief is not limited to IP. It could, for example, comprise a description of a legal matter not related to IP that said legal service or advice seeker is seeking corresponding services or advice in relation to.

Preferably, said method of said yet other and still yet other aspects of the present invention comprise a method of applying for or obtaining registered IP rights. In relation to this preferred form of said method of obtaining or providing legal services or advice said step of storing legal service provider or advisor information comprises the step of storing registering parties, said registering parties being authorised, by one or more registering organisations which grant or issue said registered IP rights, to act on behalf of said owner or originator or prospective applicant in relation to said IP with respect to said registered IP rights being applied for. This more preferred form of said method of said yet other and still yet other aspects of the present invention preferably further comprises the step of one or more of said one or more said registering parties selectively accessing each said IP of each said owner or originator or prospective applicant.

Preferably, said selectively accessing step further comprises the step of authorising said access. This authorising step preferably further comprises the step of any one or more of said owner or originator or prospective applicant authorising one or more of said one or more registering parties to access their corresponding IP. In a yet more preferred form, said authorising step further comprises the step of authorising said access via an invitation of one or more of said owner or originator or prospective applicant to one or more of said one or more registering parties to access their corresponding IP. In a further preferred form of said method of said yet other and still yet other aspects of the present invention said invitation comprises said registering parties. However, alternatively said authorising step may further comprise the step of inviting other registering parties, other than those the subject of the step defined above of storing registering parties information.

More preferably, said method of said yet other and still yet other aspects of the present invention further comprises the additional or alternative step of any one or more of said registering parties authorising their access to said IP of any one or more of said one or more owner or originator or prospective applicant. This preferred feature is preferably arranged to at least reduce any likelihood of said access by one or more of said one or more registering parties resulting in a conflict of interest.

More preferably, said step of authorising access to said IP further comprises the preceding step of providing an IP summary summarising said IP relating to one or more of said one or more owner or originator or prospective applicant. More preferably still, said access authorization step further comprises the step of authorising access only in relation to each said summary by one or more of said one or more registering parties upon confirmation by a corresponding registering party that they have reviewed said summary and do not have a conflict of interest in acting in relation to the corresponding IP. More preferably, said step of providing an IP summary further comprises the step of only including publically available information in said summary. The publically available information is more preferably publically available anywhere throughout the world but at least with respect to the country in which said registering party resides. At least for this purpose said step of storing registering party information further comprises the step of including information that identifies said registering party's jurisdiction or jurisdiction of practice, at least in relation to each said IP.

Preferably, said step of providing said IP summary further comprises the step of prompting said legal service or advice seeker for said summary. However, in a more preferred form of said yet other aspect of the present invention said step of providing said IP summary further comprises the step of automatically preparing said summary without further input from said legal service or advice seeker. In this more preferred form said IP summary means preferably comprises one or more processors arranged to compare said brief with corresponding publically available information and prepare a summary relating to said brief that only comprises publically available information.

In an alternative form of said yet other and still yet other aspects of the present invention said step of storing said brief further comprises steps corresponding to said steps of providing said IP summary. Similarly, in another alternative form of said yet other and still yet other aspects of the present invention said step of accessing said brief further comprises steps corresponding to said steps of selectively accessing said IP.

Still more preferably said step of enabling selective access to said IP summary further comprises the step of enabling any one or more of said one or more owners or originators or prospective applicants not to be identified at least to any of said one or more registering parties. By virtue of this still more preferred feature a registering party can confirm whether or not they have a conflict of interest acting in relation to said IP relating to any one or more of said one or more owners or originators or said prospective applicants without the identity of the corresponding persons whom own or are developing said IP being revealed. This ensures a registering party of said one or more registering parties is not, without authorisation, notified that persons have or are developing IP in a particular field. It also enables said one or more owners or originators or said prospective applicants to consider alternative registering parties, or other said service providers or advisors, without revealing this to their current service provider or advisor.

In yet another more preferred embodiment of said yet other and still yet other aspects of the present invention said step of accessing said IP further comprises the step of identifying one or more of: one or more of said registering parties authorised by one or more of said one or more owners or originators or prospective applicants to act on their behalf; or one or more of said owner or originator or said prospective applicant which one or more of said registering parties authorises that they can act on behalf of.

In another preferred embodiment said method of said yet other and still yet other aspects of the present invention said step of accessing said IP further comprises the step of identifying prospective clients or registering parties, including categories of prospective clients or registering parties, for whom said authorisation is not provided. For example, preferably one or more of the following are identified: specific organisations, companies or businesses; specific technologies or industries; individuals; small businesses, companies, organisations or institutions; or large businesses, companies, organisations or institutions. Preferably, said identification step comprises either or both said IP owner or originator or prospective applicant, or said registering parties.

In a preferred embodiment of said yet other and still yet other aspects of the present invention said step of storing said IP further comprises the step of at least substantially securely storing said IP to at least substantially ensure that access to it can only occur via said step of accessing said IP.

In a preferred form of said yet other and still yet other aspects of the present invention information relating to said registering parties is updated or modified by, for example, a said registering party or a third party. Said third party may, for example, comprise an administrator of said system.

More preferably said method of said yet other and still yet other aspects of the present invention further comprises the step of one or more of said one or more said registering parties assessing registrability of said IP. Preferably, said assessment step further comprises one or more steps of said assessment of said method of said one aspect of the present invention. More preferably, said assessment step further comprises the step of assessing said one or more registering parties, or correspondingly said one or more legal providers or advisors. Preferably, one or more of said assessment steps are arranged to enhance or optimize interaction of said one or more legal service providers or advisors with said brief. More preferably, one or more of said assessment steps are arranged to enhance or optimize access of one or more of said one or more legal service provider or advisor seekers to one or more of said one or more legal service providers or advisors, or one or more of said one or more legal service providers or advisors to one or more other of said one or more legal service providers or advisors.

In a preferred embodiment of said method of said yet other and still yet other aspects of the present invention one or more of said assessment steps further comprises the step of selecting an assessment from a limited number of options, for example, from ratings of 1 to 5, where 5 indicates that the IP is registerable.

In a more preferred form of said yet other and still yet other aspects of the present invention said method further comprises the step of communicating a proposal by either one or more of said one or more legal service provider or advice seekers or one or more of said one or more registering parties, or both of these, of, for example, a service arrangement for provision of a corresponding legal service or advice to either one or more of one or more of said IP owner or originator or prospective applicant or one or more of said one or more registering parties, or both of these. Preferably, said proposal communication step further comprises the step of selecting a proposal from a limited number of options comprising, for example, one or more of: an hourly charge basis; a fixed fee basis; and all-inclusive basis; or any one or more features of said agreement of said method of said one aspect of the present invention. In a still more preferred form of the yet other and still yet other aspects of the present invention said method further comprises the step of communicating confirmation of agreement between any one or more of said one or more IP owner or originator or prospective applicant and said one or more registering parties, or said one or more registering parties and any one or more other said one or more registering parties. This agreement may, for example, comprise a service or advice agreement. More preferably, said communication step further comprises the step of selecting an agreement derived from, for example, one or more said proposals of said limited number of proposals.

In another preferred embodiment of said yet other and still yet other aspects of the present invention said method further comprises the step of communicating with capital raising platforms or applications, for example, ‘Crowd Funding’ by Google Inc. More preferably however, said communication step occurs subsequent to said registered IP rights have been obtained, or a decision having been made to no longer pursue said registered rights.

Preferably, said method of said yet other and still yet other aspects of the present invention comprises the internet. More preferably, one or more features of said programmable network of said method of said yet other aspect of the present invention, said features comprising, for example, said IP storage, registering parties storage, IP access, authorization, summarizing said IP, authorization, authorization exclusion, assessment, assessment selection, proposal communication, agreement communication, agreement selection, and communication with said capital raising platforms or applications, are connected to the internet for operation at least partially via the internet or optional operation via the internet. In a more preferred form of the method of the yet other and still yet other aspects of the present invention said method steps comprise, as appropriate and as would be understood from skilled persons in the relevant field, data storage and processing. More preferably, said data storage and processing comprise corresponding electronic data storage and processing, and still more preferably, for example, one or more corresponding electronic hard drives and processors, and yet more preferably still, one or more computers or computer networks comprising said data storage and processing means. More preferably still, said method of said yet other aspect of the present invention comprises a website.

In an alternative form of said other aspect or said yet other and still yet other aspects of the present invention, said programmable network doesn't necessarily comprise the internet. In this alternative form it instead, or in addition, comprises one or more computers or computer networks. This alternative form of said other aspect of the present invention is suitable, for example, for intra organization use, for example the use described in the present description within a firm or company of lawyers or patent attorneys.

The programmable network of said other and yet other and still yet other aspects of the present invention may, for example, alternatively comprise a programmable apparatus or computer network.

“Network” as used in the present description is also not limited, for example, to a network of computers, whether or not those computers are connected via the internet. It is instead a network in the sense of a physical (visible or invisible) construction arranged to connect said legal service or advice seeker with said legal service advisor or provider, or to connect said legal service or advice seekers with each other or said legal service advisors or providers with each other. In light of this definition of “network”, and the remainder of the specification, it is also to be understood that “network” is not limited to computers or corresponding electronic data storage or processors which computers typically comprise, nor to electronic or electrical communication which is typical of electronic data storage and processors. It could, for example, instead comprise: a corresponding light based processors and a fibre optic network; electronic data storage and processors and a satellite network; or the network could, for example, partly comprise electronic data storage and processors and electronic or electrical communication but also partly comprise other means of storage, processing and communication.

All prior art disclosures referenced directly or indirectly in the present specification, and any related documents, acts, materials, devices, articles, methods or the like, is solely for the purpose of providing context for the present invention. It is not to be taken as an admission that any or all of what is disclosed in relation to these disclosures forms part of the prior art base or was common general knowledge in the field relevant to the present invention as it existed in Australia or elsewhere before the priority date of each claim of the present specification.

### BRIEF DESCRIPTION OF THE DRAWINGS

Preferred embodiments of the present invention will now be described, by way of example only, with reference to the accompanying drawings in which:

FIG. 1 is a schematic diagram of one example of a method of the present invention in the form of a method of applying for registered patent rights;

FIG. 2 is a schematic diagram of another example of a method of the present invention in the form of a method of applying for registered trademark rights;

FIG. 3 is a schematic diagram of one example of a system of the present invention relating to a method similar to that of FIG. 1 with respect to a single registering party of the present invention; and

FIG. 4 is a schematic diagram of another example of a system of the present invention of FIG. 3 but with respect to multiple registering parties of the present invention.

### DETAILED DESCRIPTION OF THE PREFERRED EMBODIMENT

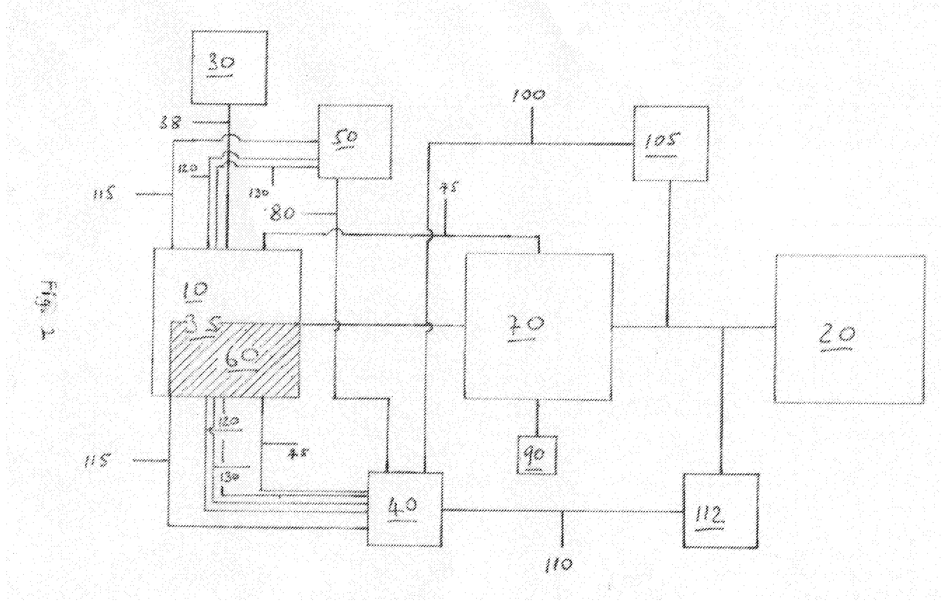

Referring to FIG. 1, a method of applying for or obtaining registered IP rights of the present invention, in this particular example, comprises a method of applying for registered patent rights 20. An originator of IP 10 corresponding to the registered patent rights 20 comprises an inventor 30 of the corresponding invention 35. Inventor 30 and her business partner, together a prospective applicant of the present invention which in this particular example comprises co-applicants 50, engage 38 a registering party of the present invention which in this particular example comprises Patent Filers 40. Co-applicants 50 require advice about obtaining the registered patent rights 20. They also require advice concerning commercial merits of the present invention which in this particular example comprise commercial merits 60 of the invention 35.

The method of applying for or obtaining registered patent rights 20 comprises an assessment fee of the present invention which in this particular example is assessment fee 80 of $3,000. The assessment fee 80 comprises an assessment of the present invention which in this particular example comprises assessment 70 of the registrability and commercial merits 75 of the invention 35. The assessment 70 comprises a rating of the present invention which in this particular example is rating 90. The value of the rating 90 is 4/5.

The rating 90 is greater than or equal to a predetermined value of the present invention which in this particular example is 4. Patent Filers 40 therefore agree that in addition to applying for registered patent rights 20 on behalf of the co-applicants 50, they will reasonably pursue grant or issuance of registered patent rights 20. Patent Filers 40 also additionally agree, due also to the value of the rating 90 being 4, to reasonably assist and advise in relation to commercialisation. Furthermore, due to the value of the rating 90 Patent Filers 40 also agree to pay all official fees 100 payable to registering bodies of the present invention, which in this particular example comprise patent offices 105 of jurisdictions of the registered patent rights 20. And because the value of the rating 90 is 4 Patent Filers 40 also agree to pay fees 110 of other registering parties 112 of the present invention which in this particular example comprise associates engaged by Patent Filers 40 in respect of jurisdictions of the registered patent rights 20 for which Patent Filers 40 are not authorised to act on behalf of the co-applicants 50.

In accordance with the method of applying for or obtaining registered patent rights 20, co-applicants 50 agree to pay Patent Filers 40 a percentage of revenue of the present invention which in relation to patent rights 20 comprises revenue percentage 115 of 30% of all revenue derived from exploitation of the IP 10. Co-applicants 50, also in accordance with the method of applying for registered patent rights 20, agree to assign 120 registered patent rights 20 to Patent Filers 40 and Patent Filers 40 exclusively and irrevocably licence 130 co-applicants 50 to exploit the invention 35.

If the co-applicants 50 do not reasonably endeavor to exploit the invention 35 or implement the commercialisation advice of Patent Filers 40 then Patent Filers 40 may, in accordance with their agreement with co-applicants 50, choose to not continue paying the fees 100 or 110.

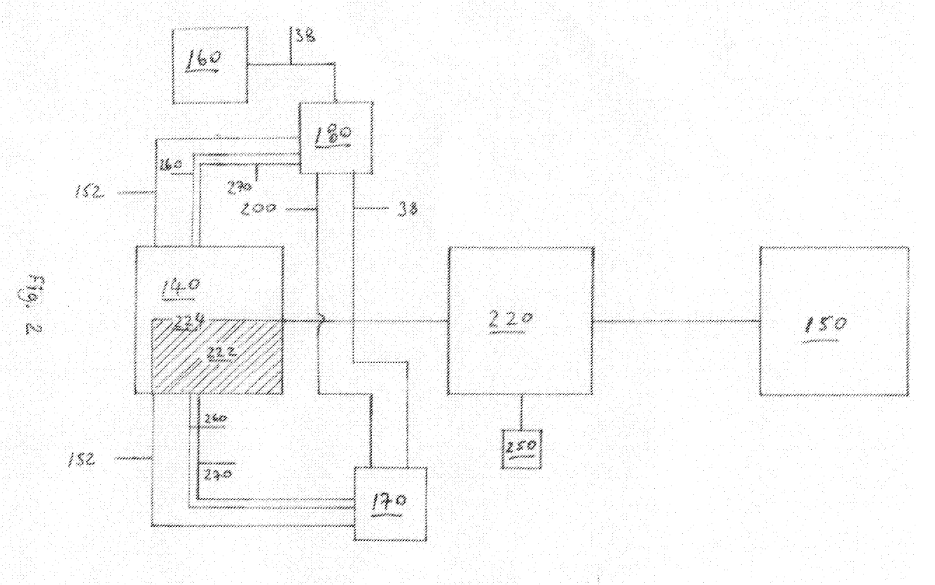

Referring to FIG. 2, a method of applying for or obtaining registered IP rights of the present invention, in this particular example, comprises a method of applying for or obtaining registered trademark rights 150. An originator of IP 140 corresponding to the registered trademark rights 150 comprises trademark originator 160. The trademark originator 160 engages 38 a registering party of the present invention which in this particular example comprises Patent and Trademark Filers 170. Trademark originator 160, a prospective applicant of the present invention in the form of applicant 180, requires advice about obtaining the registered trademark rights 150.

The method of applying for or obtaining registered trademark rights 150 comprises an assessment fee of the present invention which in this particular example is assessment fee 200 of $1,000. The assessment fee 200 comprises an assessment of the present invention which in this particular example comprises assessment 220 of the registrability 222 of trademarks 224 of the IP 140. The assessment 220 comprises a rating of the present invention which in this particular example is rating 250. The value of the rating 250 is 3/5.

The rating 250 is greater than or equal to a predetermined value of the present invention which in this particular example is 2. Patent and Trademark Filers 170 therefore agree that in addition to applying for registered trademark rights 150 on behalf of the applicant 180, they will reasonably pursue registration of the registered trademark rights 150.

In accordance with the method of obtaining registered trademark rights 150, the applicant 180 agrees to pay Patent and Trademark Filers 170 a percentage of revenue of the present invention which in relation to the method of applying for or obtaining trademark rights 150 comprises revenue percentage 152 of 15% of all revenue derived from exploitation of the IP 140. Applicant 180, also in accordance with the method of applying for or obtaining registered trademark rights 150, agrees to assign 260 the registered trademark rights 150 to Patent and Trademark Filers 170 and Patent and Trademark Filers 170 exclusively and irrevocably licence 270 applicant 180 to exploit the IP 140.

If applicant 180 does not reasonably endeavor to exploit the IP 140, Patent and Trademark Filers 170 may choose to not continue pursuing registered trademark rights 150.

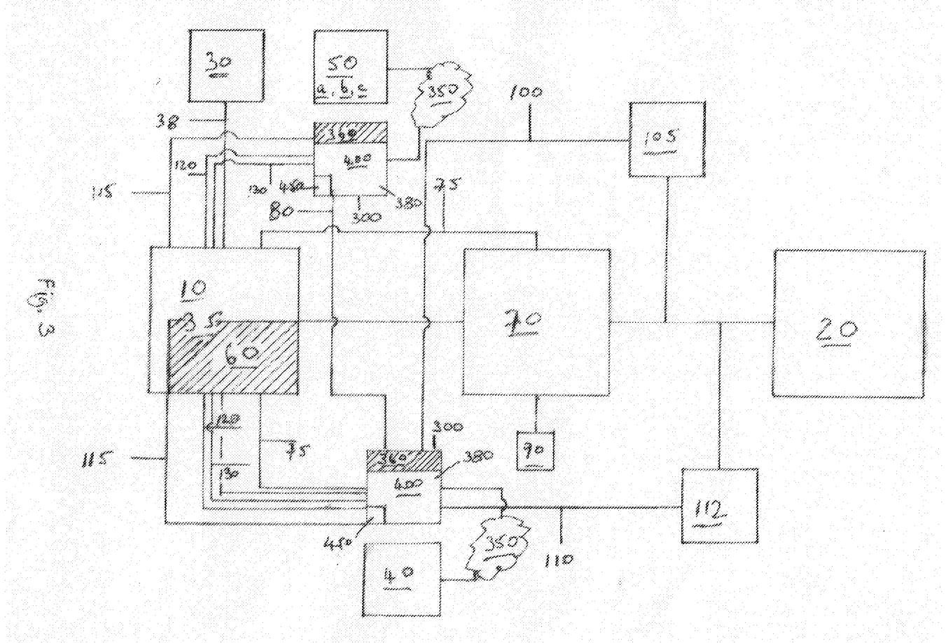

Referring to FIG. 3, one example of a programmable network of said other aspect of the present invention comprises a registered IP rights platform 300. The registered IP rights platform 300, in this particular example, is web based and connects via the internet 350 to an owner or originator of IP or a prospective applicant of an application for registration of corresponding registered IP rights of the system of the present invention. In this particular example the registered IP rights platform 300 also connects, via the internet 350, applicants 50a, 50b, 50c etcetera. These applicants in turn become connected via the IP rights platform 300 and the internet 350 to registering parties of the system of the present invention which in this particular example comprise Patent Filers 40.

The registered IP rights platform 300 of this particular example one or more computers having data storage and processing capability. The data storage capability comprises IP storage means of the other aspect of the present invention which in this particular example comprises a secure IP section 360 of the platform 300. The secure IP section 360, in this particular example, comprises one or more hard drives and is designed so that IP corresponding to each applicant 50a, 50b, 50c etc is only visible to the corresponding applicant. The design of the secure IP section 360 comprises appropriate security features including for example password protection and 128 Bit encryption. However, it also includes any other security features that would be readily apparent to persons skilled in the relevant field.

The secure IP section 360 is connected to Patent Filers 40 via IP storage access means of the programmable network of the present invention which in this particular example comprises secure IP access section 380. The data processing capability of the IP rights platform 300 comprises the secure IP access section 380 which in this particular example comprises one or more computers comprising processors. The secure IP access section 380 is designed to control access to the IP section 360 by Patent Filers 40. It is also designed to separately control access to IP corresponding to each applicant 50a, 50b, 50c etc.

In relation to IP data corresponding to each applicant 50a, 50b, 50c etc, before Patent Filers 40 can access that data the secure IP access section 380 requires Patent Filers 40 to review a corresponding summary of the IP. The summary is provided by IP summary means of said other aspect of the present invention which in this particular example comprises abstracts 400. The abstracts 400 comprise only publically available information and do no reveal information relating to the corresponding applicant 50a, 50b, 50c etc, including their name or any other details. Based on their review of one or more abstracts 400 Patent Filers 40 confirm via the secure IP access section 380 whether or not they can act in relation to the corresponding IP without a conflict of interest.

The secure IP access section 380 also excludes Patent Filers 40 from IP abstracts 400 which are excluded by identity authorization exclusion means of said other aspect of the present invention which in this particular example comprises exclusion from access list 450. The exclusion from access list 450 quarantines IP corresponding to applicants 50a, 50b, 50c etc from access by Patent Filers 40 if, for example, either the applicants 50a, 50b, 50c etc or the technology of their corresponding IP has been identified, in this particular example, as being included in the exclusion from access list 450 by either the applicants 50a, 50b or 50c or Patent Filers 40. Of those abstracts that Patent Filers 40 can access, Patent Filers 40 can choose to communicate, via communication facilitation means of said other aspect of the present invention, with one or more applicants 50a, 50b or 50c in relation to their corresponding IP. In this particular example, registered IP rights platform 300, the communication facilitation means comprises text and graphic enabled communication boxes of, for example, a computer screen.

The registered IP rights platform 300 also includes all said features of said communication facilitation means of said other aspect of the present invention, which in this particular example, comprises all features of the method of applying for registered patent rights 20 of FIG. 1. Patent Filers 40 can therefore offer to agree as they did in relation to the example of the registered patent rights 20. However, they can also offer additional or alternative service arrangements comprising, for example, one or more of: an hourly charge basis; a fixed fee basis; or an all-inclusive basis.

Also included in the registered IP rights platform 300 are other features of said communication facilitation means of said other aspect of the present invention including the time recording means and corresponding features of the IP storage access means relating to conversion of viewing time to a corresponding charge. These feature may, as would be readily apparent to persons skilled in the relevant art manifest in many different ways. One example of their incorporation into the IP rights platform 300 is as follows. Patent Filer 40 specifies a Charge Out rate, which can either be the same for all applicants 50a, 50b or 50c, or can be differentiated for specific applicants from charges for other applicants. When Patent Filer 40 is viewing the IP data referred to above their viewing time is recorded. Any time communicating with applicants 50a, 50b or 50c is also recorded. The recorded time is converted to a charge using the Charge Out rate referred to above.

However, before Patent Filer 40 is authorised to act for any one or more of applicants 50a, 50b or 50c, each of these applicants is required to preapprove an initial charge by Patent Filer 40 and provide those funds to the registered IP rights platform 300 for processing by Patent Filer 40. Patent Filer 40 also has a corresponding obligation before any one or more of applicants 50a, 50b or 50c can confirm that they would like Patent Filer 40 to act on their behalf, at least in a preliminary manner. They are required to confirm whether they will provide an initial period of time free of charge and if so what that period is and what it is likely to convert to in terms of the service or advice that applicants 50a, 50b or 50c are seeking.

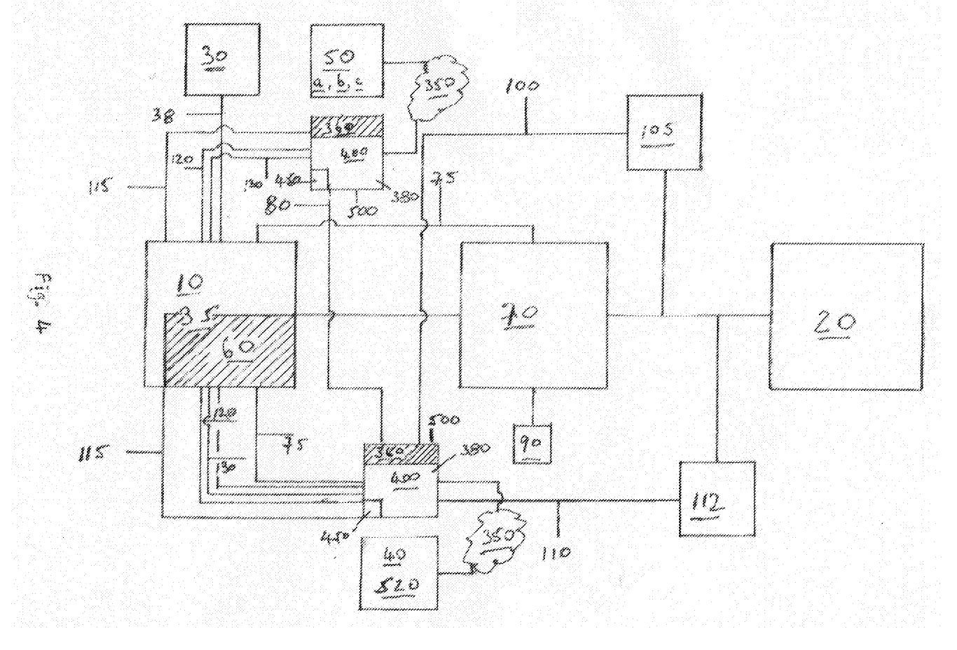

Referring to FIG. 4, another example of a programmable network of said other aspect of the present invention comprises a registered IP rights platform 500. The registered IP rights platform 500 is similar to the registered IP rights platform 300 in that it connects applicants 50a, 50b, 50c etcetera via the internet 350 to Patent Filers 40. However, it differs in that it also connects applicants 50a, 50b, 50c etc to Other Patent Filers 520. The Other Patent Filers 520 includes any number of registering parties of the present invention.

The registered IP rights platform 500 also differs from the corresponding platform 300 of FIG. 3 as follows. The exclusion from access list 450 also quarantines Patent Filers 40 or any one or more said registering parties of the Other Patent Filers 520 from access to the IP of applicants 50a, 50b, 50c etc if, for example, those applicants have identified, in this particular example, said registering parties as being included in a corresponding exclusion list.

However, in relation to the IP rights platform 500, only registering parties of the programmable network of the present invention, which in relation to this particular example comprise Patent Filers 40 and Other Patent Filers 520, that are identified by the identity authorization means of the system of the present invention can access the abstracts. In this particular example the identity authorization means comprises a database that is compiled from requested input from both Patent Filers 40 and Other Patent Filers 520 and applicants 50a, 50b and 50c. If no input is provided from a specific party to the IP rights platform 500, e.g. an applicant 50a or one of the Other Patent Filers 520, then a default position is selected in relation to that party. The default position of this particular example is, by way of example, that a corresponding abstract is made available by the applicant 50a that did not respond, or all abstracts are made available to the one of the Other Patent Filer 520 from which no response was received by the IP rights system 500.

The registered rights platform 500 also allows Patent Filers 40 and Other Patent Filers 520 to publish to applicants 50a, 50b, 50c etc. via proposal communication means of the programmable network of the present invention their proposal. This proposal may, for example, comprise features of the agreement between Patent Filers 40 and co-applicants 50 with respect to the method of applying for registered patent rights 20 of FIG. 1. However, it could also, for example, comprise any other terms of trade features. One or more of the applicants 50a, 50b, 50c etc. can then invite one or more of the service providers (Patent Filers 40 and Other Patent Filers 520) to access the secure IP section 360 in relation only to their IP, and assess it using assessment selection means of the programmable network of the present invention which in this particular example comprise ratings as, for example, used in relation to the methods 20 and 150 described above. Prior to these assessments the applicants 50a, 50b, 50c etc. would agree to the terms of trade of the invited parties, including any corresponding charges. After assessing or evaluating the IP the corresponding rating, for example the rating 90 of the method of applying for registered patent rights 20, would determine what services or work, if any, that any further proposal by any one or more of the Patent Filers 40 and Other Patent Filers 520 may comprise. Applicant 50a, 50b, 50c etc can then either accept or decline a corresponding service arrangement via agreement communication means of the programmable network of the present invention which in this particular example comprises accepting a corresponding agreement put forward by a service provider or provider of advice. Patent Filers 40 and Other Patent Filers 520 select the agreement via agreement selection means of the programmable network of the present invention which in this particular example comprises selecting an agreement from agreements drafted to correspond to 10 alternative proposals. However, Patent Filers 40 and Other Patent Filers 520 are also able to offer their own alternative agreement.

It will be appreciated that the invention in at least one of its preferred forms has at least the following possible advantages:
1. Inventors and other IP owners and originators and corresponding prospective applicants for corresponding registered IP rights have increased certainty about the application process and its cost;
2. Inventors and other IP owners and originators and corresponding prospective applicants for corresponding registered IP rights also have increased certainty concerning commercialisation of the IP including the corresponding process and its cost;
3. Costs identified at items 1 and 2 are typically at least substantially, but possibly more likely vastly, reduced;
4. Advantages corresponding to those of items 1 to 3 above in relation to other services and advice, for example, other legal services and advice;
5. Charges and corresponding services of competing service providers, for example, Patent Filers 40 and Patent and Trademark Filers 170, that may be engaged, for example, by inventors and other IP owners and originators and corresponding prospective applicants at least for corresponding registered IP rights but possibly also corresponding commercialisation, are at least likely to be more easily compared. This is at least likely to make these charges and corresponding processes more transparent and comparable and lead to reduced costs for, for example, applying for and obtaining registered IP rights, and increased certainty concerning the corresponding process;
6. Service providers, for example, Patent Filers 40 and Patent and Trademark Filers 170, that may be engaged, for example, by inventors and other IP owners and originators and corresponding prospective applicants for corresponding registered IP rights and commercialisation of the IP are focused solely, for example, on the IP, its protection and corresponding commercial returns. There is no possible conflict of interest for these service providers between serving those whom engage them and generating revenue for their services. Service provider remuneration is directly linked, for example, to commercialisation of the IP and unrelated to any other measure of service provider input, for example, time spent or hours billed; and
7. The registered rights platforms 300 and 500 also apply, for service and advice providers, intra firm. That is, service providers and advisers of, for example, the same firm can also communicate via the registered rights platforms 300 and 500, for example. One of the advantages of this application of said other aspect and yet other aspect of the present invention is that information relating to a client is only disclosed, for example, to specific lawyers or patent attorneys whom are employed by or part owners of, for example, a firm or company of lawyers or patent attorneys. This application may also be useful, for example, in providing more effective “Chinese Walls” which may enable more legal firms or companies to represent clients having overlapping legal rights or competing interests.

It will be appreciated by persons skilled in the art that numerous variations or modifications may be made to the invention as shown in the specific embodiments without departing from the spirit or scope of the invention as broadly described. For example, registered design rights may be the subject of the method of the present invention of applying for registered IP rights. In still another example the relationship between assessments fees such as 80 and 200, corresponding respective ratings 90 and 250 and corresponding respective exploitation revenue percentages of 30 and 15 may be different to these examples or those defined in the summary of the invention section of the present specification. The present embodiments are, therefore, to be considered in all respects as illustrative and not restrictive.

1. A programmable network arranged for obtaining or providing legal services or advice, said programmable network comprising brief storage means for storing a brief of one or more legal service or advice seekers seeking a corresponding service or corresponding advice, and legal service provider or advisor brief storage access means arranged for enabling access by one or more legal service providers or advisors to said brief storage means, wherein said brief storage access means is further arranged for selective access by each of said one or more legal service providers or advisors to each said brief of said one or more legal service or advice seekers.

2. A programmable network as claimed in claim 1 wherein said brief storage access means further comprises time recording means arranged to record time spent by said one or more legal service providers or advisors viewing said brief.

3. A programmable network as claimed in claim 1 wherein said legal service provider or advisor brief storage access means is further arranged to identify one of more of said one or more legal service or advice seekers or said one or more legal service providers or advisors with respect to any one or more of said one or more legal service providers or advisors, any one or more of said one or more legal service or advice seekers, or both.

4. A programmable network arranged as claimed in claim 3 wherein said programmable network further comprises legal service provider or advisor storage means arranged for storing information relating to one or more of said one or more legal service providers or advisors.

5. (canceled)

6. A programmable network as claimed in claim 1 wherein said programmable network further comprises communication facilitation means arranged for at least partially facilitating respective communication between one or more of said one or more legal service or advice seekers or said one or more legal service providers or advisors and any one or more of said one or more legal service providers or advisors, any one or more other of said one or more legal service or advice seekers, or both.

7. (canceled)

8. A programmable network as claimed in claim 1 wherein said brief comprises IP of an owner or originator of said IP or a prospective applicant of an application for registration of corresponding registered IP rights.

9-11. (canceled)

12. A programmable network as claimed in claim 1 wherein said legal service provider or advisor brief storage access means comprises authorization means arranged for authorizing said access.

13. (canceled)

14. A programmable network as claimed in claim 7 wherein said authorization means is arranged to authorize said access via an invitation of one or more of said legal service or advice seeker to one or more of said one or more legal service provider or advisor to access their corresponding brief.

15. (canceled)

16. A programmable network arranged as claimed in claim 1 wherein said legal service provider or advisor brief storage access means further comprises brief summary means for providing a summary of said brief relating to one or more of said one or more legal service or advice seekers.

17. A programmable network as claimed in claim 16 wherein said authorization means is further arranged to only authorize access in relation to each said brief by one or more of said one or more legal service providers or advisors upon confirmation by a corresponding legal service provider or advisor that they have reviewed said brief summary and do not have a conflict of interest in acting in relation to the corresponding brief.

18. A programmable network as claimed in claim 17 wherein said brief summary only comprises publically available information relating to said brief.

19. A programmable network as claimed in claim 3 wherein said legal service provider or advisor brief storage access means comprises identity authorization means arranged for identifying one or more of: one or more of said legal service providers or advisors authorized by one or more of said one or more legal service or advice seekers to act on their behalf; or one or more of said legal service or advice seekers which one or more of said legal service providers or advisors authorizes that they can act on behalf of.

20. A programmable network as claimed in claim 3 wherein said legal service provider or advisor brief storage access means further comprises authorization exclusion means arranged for identifying prospective legal service or advice seekers or legal service providers or advisors, including categories of these, for whom said authorization is not provided.

21. A method of operating a programmable network to obtain or provide legal services or advice, said programmable network comprising brief storage means for storing a brief of one or more legal service or advice seekers seeking a corresponding service or corresponding advice, and legal service provider or advisor brief storage access means arranged for enabling access by one or more legal service providers or advisors to said brief storage means, said method comprising the steps of:
a. storing, via said brief storage means, a brief of one or more legal service or advice seekers seeking a corresponding service or corresponding advice; and
b. one or more legal service providers or advisors selectively accessing, via said legal service provider or advisor brief storage access means, each said brief of said one or more legal service or advice seekers.

22. A method of obtaining or providing legal services or advice, said method comprising the steps of:
a. storing a brief of one or more legal service or advice seekers seeking a corresponding service or corresponding advice; and
b. one or more legal service providers or advisors selectively accessing each said brief of said one or more legal service or advice seekers.

23. A method as claimed in claim 22 further comprising the step of identifying said one or more legal service or advice seekers or said one or more legal service providers or advisors with respect to any one or more of said one or more legal service providers or advisors, any one or more other of said one or more legal service or advice seekers, or both.

24. (canceled)

25. (canceled)

26. (canceled)

27. A method as claimed in claim 22 wherein said method comprises a method of applying for or obtaining registered IP rights.

28. (canceled)

29. (canceled)

30. (canceled)

31. (canceled)

32. A method as claimed in claim 22 further comprising the step of any one or more of said legal service provider or advisor authorizing their access to said brief of any one or more of said one or more legal service or advice seeker.

33. A method as claimed in claim 32 further comprising the preceding step of providing a brief summary summarizing said brief relating to one or more of said one or more legal service or advice seekers which only includes publically available information.

34. A method as claimed in claim 33 wherein said access authorization step further comprises the step of authorising access only in relation to each said brief by one or more of said one or more legal service providers or advisors upon confirmation by a corresponding legal service provider or advisor that they have reviewed said brief summary and do not have a conflict of interest in acting in relation to said corresponding brief.

35-72. (canceled)
